(19) United States
(12) Patent Application Publication
(10) Pub. No.: US 2025/0098632 A1
(43) Pub. Date: Mar. 27, 2025

(54) MOBILE FEED CONTROL AND MONITORING SYSTEM AND METHOD THEREOF

(71) Applicant: EBSCO Industries, Inc., Birmingham, AL (US)

(72) Inventors: Joseph TATE, Pelham, AL (US); Terry PLUNKETT, Sterrett, AL (US); Robert P. SCHIEFER, Jr., Helena, AL (US); Daniel Clifton WILSON, Chelsea, AL (US); Darrin DURHAM, Sterrett, AL (US)

(21) Appl. No.: 18/474,186

(22) Filed: Sep. 25, 2023

(51) Int. Cl. A01K 5/02

(52) U.S. Cl. CPC A01K 5/0275; A01K 5/0291

(57) ABSTRACT

A mobile feed control and/or monitoring system for an animal feeder may include one or more of a feed control unit or a feed level sensing unit. One of the feed control unit or the feed level sensing unit may include a network communication device configured to provided a cellular network connection to a cloud network accessible from a user device. The other one of the feed control unit or the feed level sensing unit may be configured to send data locally to the one of the feed control unit or the feed level sensing unit including the network communication device which may send data to the user device. The feed control unit may be configured to control a state of a dispenser of the animal feeder. The feed level sensing unit may be configured to sense an amount of feed remaining in a hopper of the animal feeder.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The present invention relates generally to animal feeders. More particularly, the present disclosure pertains to animal feeder data control and distribution systems.

### 2. Description of the Prior Art

Animal feeder systems (also called “game feeder systems,” “deer feeder systems”, “fish feeder systems,” “bird feeder systems” or simply “feeder systems”) allow users to control the dispensing of animal feed, such as deer feed (typically, but not necessarily, comprising corn) remotely.

A feed station has a feed storage tank having an opening for dispensing feed (or other food), dispensing system that typically includes a dispenser coupled to the opening, an actuator coupled to a dispenser such that the actuator opens and shuts the dispenser to selectively allow feed to flow from the feed storage tank. A scatter plate is typically coupled to the feed storage tank through a dispensing system, and the feed station may include a structure to lift the feed storage tank off the ground. More recently, remote control unit(s) have been added to feed stations. These units control the dispensing of the feed, including, of course, deer feed.

Due in part to their remoteness, as well as the fact that they maintain a limited supply of a consumable product (which may include the feed), as well as modifying feed schedules based on animal need, weather or other external events, reliable continuous deer feeder systems in reality require constant supervision and maintenance and are not “set it and forget it” devices.

The result is a hunter or wildlife viewer may be frustrated when they spend a morning or afternoon returning to a location expecting animals to be present, but instead the animals have vanished because the feed station quit working. Equally frustrating, a hunter or wildlife viewer may be at or near a feed station, assuming that it is working properly, while animals simply walk by. For example, a deer may walk out of the visual range of a hunter because the feed that should be available to attract the deer is not dispensing from the feeder due to a malfunction, such as a loss of power at the deer feeder.

### BRIEF SUMMARY

In view of at least some of the above-referenced problems in conventional remote animal feeding unit, an exemplary object of the present disclosure may be to provide a new system and method for controlling the dispensing of feed and/or monitoring of vital information of a remote animal feeding unit and transmission to a receiving source, such as, for example, a user device. With sensor data from this apparatus and/or derived events therefrom which require maintenance interventions or equivalent correctional actions, users may quickly locate and service the remote animal feeding unit to minimize downtimes and ensure continuous functionality of the remote animal feeding unit.

In a particular embodiment, an exemplary wireless feed control system configured to be coupled to an animal feeder including at least a hopper and an electronic dispenser as disclosed herein may include a feed control unit and a feed level sensing unit. The feed control unit configured to be coupled to the electronic dispenser of the animal feeder. The feed control unit may include a network communication device configured to provide a cellular network connection to a cloud network accessible from a user device, a local wireless receiver, and a controller operatively configured to control a state of the electronic dispenser of the animal feeder based upon user inputs from the user device. The feed level sensing unit may be separate from the feed control unit and may be configured to be coupled within the hopper of the animal feeder. The feed level sensing unit may be configured to capture data corresponding to an amount of feed in the hopper as well as optionally capture the hopper environment and quality of the feed and transmit the data to the feed control unit using a wireless transceiver in wireless communication with the local wireless receiver of the feed control unit. The data from the feed level sensing unit and additional data from the feed control unit may be configured to be transmitted to the user device from the feed control unit.

In an exemplary aspect according to the above-referenced embodiment, the user inputs may include creating a feed schedule including automatic feed times when the state of the electronic dispenser is active.

In another exemplary aspect according to the above-referenced embodiment, the controller may be configured to calculate an amount of time until the hopper of the animal feeder is empty based at least in part on the feed schedule and the data from the feed level sensing unit.

In another exemplary aspect according to the above-referenced embodiment, the user inputs may include selection of one or more rules that automatically adjust or override one or more of the automatic feed times of the feed schedule. In accordance with this aspect, the one or more rules may be based at least in part on one or more of whether data, seasonal data, moon phase data, or sunrise/sunset data.

In another exemplary aspect according to the above-referenced embodiment, the feed control unit may be configured to transmit one or more alerts from the feed control unit to the user device in response to one or more events.

In another exemplary aspect according to the above-referenced embodiment, the one or more events may include tampering event.

In another exemplary aspect according to the above-referenced embodiment, the tampering event may be generated based on movement of the feed level sensing unit.

In another exemplary aspect according to the above-referenced embodiment, the tampering event may be generated based on data from an accelerometer positioned within one of the feed control unit or the feed level sensing unit.

In another exemplary aspect according to the above-referenced embodiment, the one or more events may include a malfunction of the electronic dispenser of the animal feeder.

In another exemplary aspect according to the above-referenced embodiment, the malfunction may include one or more of a jammed state, a clogged state, or a spin state.

In another exemplary aspect according to the above-referenced embodiment, battery level data of the feed control unit may be configured to be transmitted to the user device.

In another exemplary aspect according to the above-referenced embodiment, the data captured by the feed level sensing unit may include a temperature associated with an interior of the hopper of the animal feeder.

In another exemplary aspect according to the above-referenced embodiment, the data captured by the feed level sensing unit may include a humidity associated with an interior of the hopper of the animal feeder.

In another exemplary aspect according to the above-referenced embodiment, the data captured by the feed level sensing unit may include one or more of a grain type or a grain weight associated with feed disposed within the hopper.

In another exemplary aspect according to the above-referenced embodiment, the data captured by the feed level sensing unit may include a battery level measurement corresponding to batteries of the feed level sensing unit. We also want to include battery measurement data for any remote sensors.

In another embodiment, a method of monitoring an animal feeder is disclosed herein. The method may include coupling a feed level sensing unit within a hopper of the animal feeder, the feed level sensing unit configured to generate data corresponding to a level of feed in the hopper; determining an amount of time until the hopper is empty based at least in part on the level of the feed in the hopper; and transmitting the data from the feed level sensing unit to a user device, the data including the determined amount of time until the hopper is empty.

In another embodiment, a method of controlling an animal feeder is disclosed herein. The method may include coupling a feed level sensing unit within a hopper of the animal feeder, the feed level sensing unit configured to generate data corresponding to a level of feed in the hopper; coupling a feed control unit to an electronic dispenser of the animal feeder, the feed control unit configured to control a state of the electronic dispenser based upon user inputs wirelessly communicated from a user device; automatically dispensing feed from the animal feeder based upon the user inputs, the user inputs include a feed schedule; and transmitting the data from the feed level sensing unit to the user device via the feed control unit.

In an exemplary aspect according to the above-referenced embodiment, the feed schedule may be one or more of time dependent, day dependent, weather dependent, season dependent, or sunrise/sunset dependent.

In another exemplary aspect according to the above-referenced embodiment, the method may further include determining an amount of time until the hopper is empty based at least in part on the level of the feed in the hopper and the feed schedule.

In another exemplary aspect according to the above-referenced embodiment, the method may further include adjusting the feed schedule based on the amount of time until the hopper is empty to increase the amount of time until the hopper is empty.

### BRIEF DESCRIPTION OF THE SEVERAL VIEWS OF THE DRAWINGS

FIG. 1 is a front elevation partial cross-sectional view of an embodiment of a mobile feed control system in accordance with the present disclosure.

FIG. 2 is a block diagram of the mobile feed control system of FIG. 1 in accordance with the present disclosure.

FIGS. 3-5 are block diagrams of a user interface on a user device in accordance with the present disclosure.

FIG. 6 is a front elevation partial cross-sectional view of an embodiment of a mobile feed monitor system in accordance with the present disclosure.

FIG. 7 is a block diagram of the mobile feed monitor system of FIG. 6 in accordance with the present disclosure.

FIG. 8 is a flow diagram of an embodiment of a method of monitoring an animal feeder in accordance with the present disclosure.

FIG. 9 is a flow diagram of an embodiment of a method of controlling an animal feeder in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “computing platform” or “platform” may include a computing environment where a portion of software can execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The computing platform may include one or more data storages. The computing platform may include a client application that executes on an external computing device and that interacts with the platform in a client-server architecture.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing”, and other similar terms may include a variety of actions. For example, accessing data may include obtaining the data, examining the data, or retrieving the data. Providing access or providing data access may include providing confidentiality, integrity, or availability regarding the data.

As used herein, the term “message” may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described, such software application able to both send and receive pertinent performance data.

As used herein, the term “modify” or “modifying” may include several actions. For example, modifying data may include adding additional data or changing the already-existing data. As used herein, the term “obtain” or “obtaining” may also include several types of action. For example, obtaining data may include receiving data, generating data, designating data as a logical object, or other actions.

As used herein, the term “data object” may include a logical container for data. A data object may include an instance of an object in a software application implemented with an object-oriented programming language. A data object may include data formatted in an electronic data interchange (EDI) format, such as an Extensible Markup Language (XML) object, a JavaScript Object Notation (JSON) object, or some other EDI-formatted object. A data object may include one or more functions that may manipulate the data of the data object. For example, a data object may include the functions or methods of an object in a software application implemented with an object-oriented programming language.

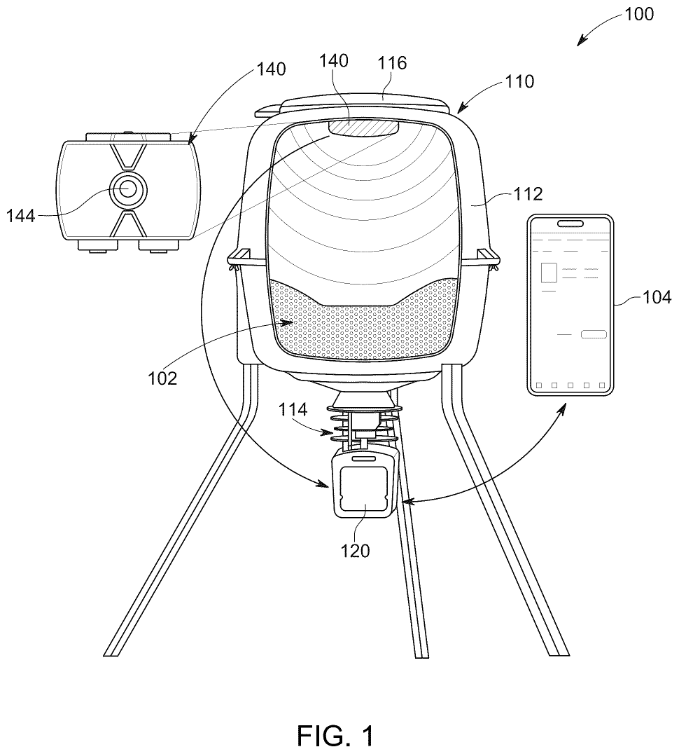

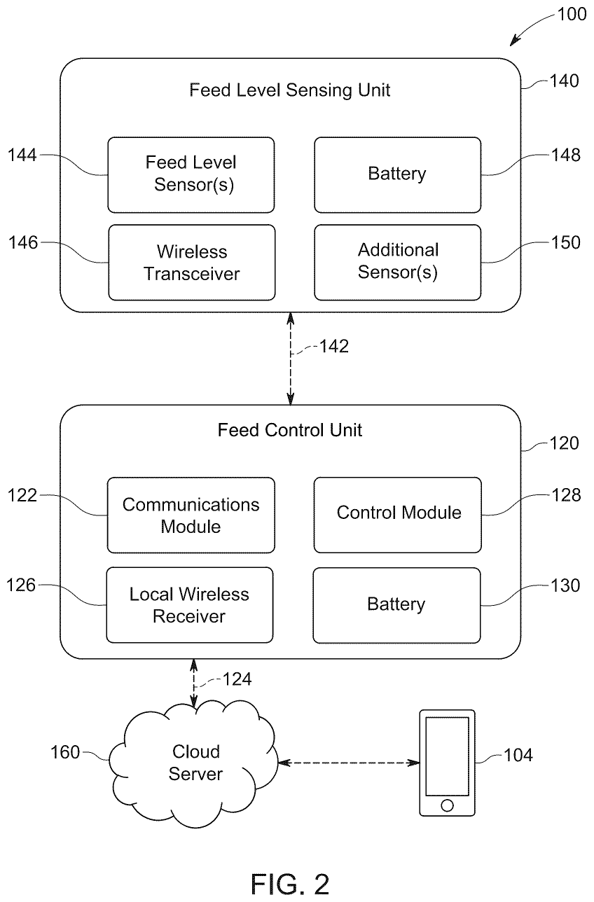

Referring to FIGS. 1-2, a wireless feed control system 100 is illustrated. The wireless feed control system 100 may also be referred to herein as a system 100. The wireless feed control system 100 may be configured to be coupled to an animal feeder 110, for example, as an add-on or retrofit kit for modifying the functionalities of the animal feeder 110. The animal feeder 110 may include at least a hopper 112 and an electronic dispenser 114. The electronic dispenser may be configured to dispense feed 102 contained in the hopper 112 based upon electrical control signals. Feed 102 may also be referred to herein as animal feed 102, and may be corn, pelletized meal, or the like.

The wireless feed control system 100 may include one or more of a feed control unit 120 or a feed level sensing unit 140. As illustrated in FIG. 1, the feed control unit 120 may be configured to be coupled to the electronic dispenser 114 of the animal feeder 110. The feed level sensing unit 140 may be separate from the feed control unit 120. The feed level sensing unit 140 may be configured to be coupled within the hopper 112 of the animal feeder 110. In certain optional embodiments, the feed level sensing unit 140 may be coupled to a bottom surface of a lid 116 of the hopper 112 of the animal feeder 110, as illustrated in FIG. 1.

Referring to FIG. 2, additional details of the wireless feed control system 100 are shown. The feed control unit 120 may include a communication module 122. The communication module 122 may also be referred to herein as a network communication device 122. The communication module 122 may be configured to provide a cellular network connection to a cloud server 160 which may be accessible from a user device 104. The cloud server 160 may also be referred to herein as a cloud network 160 or a data network 160. The user device 104 may also be referred to herein as a computing device 104 or computing platform 104. Data 124 from the feed control unit 120 may be transmitted to the cloud server 160 via the cellular network connection. The feed control unit 120 may include a local wireless receiver 126 configured to communicate with the feed level sensing unit 140. The local wireless receiver 126 may operate using Bluetooth, Wi-Fi direct, Near Field Communication (NFC), Infrared (IR), Zigbee, Z-Wave, Ultra-Wideband (UWB), Radio Frequency Identification (RFID), ANT, Thread, or the like.

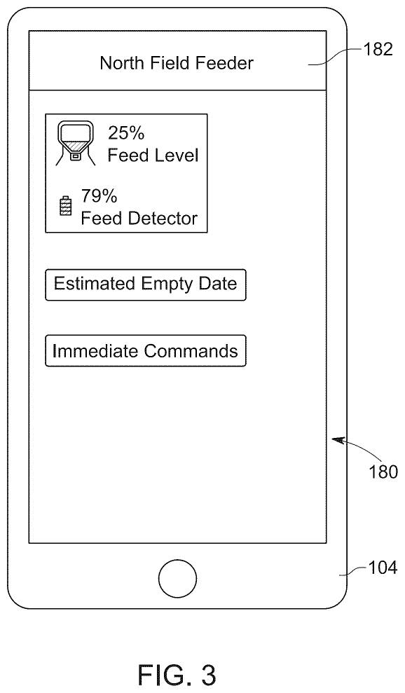

The feed control unit 120 may further include a control module 128. The control module 128 may operatively be configured to control a state (e.g., activated or deactivated) of the electronic dispenser 114 of the animal feeder 110, for example, based upon user inputs from the user device 104. The user device 104 may include a screen that can display a user interface (UI) 180, illustrated in FIGS. 3-5. The UI 180 may include a UI of an application for communicating with the feed control unit 120.

The term “controller” or equivalents thereof as used herein may refer to, be embodied by or otherwise included within a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. A general purpose processor can be a microprocessor, but in the alternative, the processor can be a microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The feed level sensing unit 140 may be configured to capture data 142 which may at least correspond to an amount of the feed 102 left in the hopper 112 using one or more feed level sensors 144. The one or more feed level sensors 144 may, for example, be a Time-of-Flight sensor, an infrared sensor, a photo sensor, a mechanical spring-loaded paddle sensor (e.g., similar to those in corn silos), or the like. The feed level sensing unit 140 may further include a wireless transceiver 146. The wireless transceiver 146 may be configured to wirelessly communicate with the local wireless receiver 126 of the feed control unit 120 for transmitting the data 142 to the feed control unit 120. In other optional embodiments, the local wireless receiver 126 and the wireless transceiver 146 may be replaced with physical connections (e.g., a wired connection) between the feed control unit 120 and the feed level sensing unit 140. In further optional embodiments, the feed control unit 120 and the feed level sensing unit 140 may be combined into a single unit. The feed level sensing unit 140 may send the data 142 at known times to the feed control unit 120. The feed level sensing unit 140 may synchronize with the feed control unit 120 at power up and can adjust the transmission windows based on when the packet is received at the feed control unit 120. The data 142 may be formatted to include one or more of the feed level, battery level, humidity, temperature, or the like.

Each of the feed control unit 120 and the feed level sensing unit 140 may include a battery 130, 148, respectively, for powering the various components thereof. In certain optional embodiments, the feed control unit 120 may receive power directly from a power source of the electronic dispenser 114, thereby making its battery 130 unnecessary. The data 142 from of the feed level sensing unit 140 may include battery level data corresponding to the battery 148. Similarly, battery level data corresponding to the battery 130 of the feed control unit 120 may be included in the data 124 for transmission to the user device 104.

In certain optional embodiments, the feed level sensing unit 140 may further include one or more additional sensors 150. The one or more additional sensors 150 may include a temperature sensor, a humidity sensor, an accelerometer, a grain type sensor, a grain weight sensor, or the like. The data 142 may include data from each of the one or more additional sensors 150, which may be optionally included. The temperature sensor may measure a temperature within the hopper 112. The humidity sensor may measure a humidity within the hopper 112. The grain type sensor may determine a type of the feed 102 within the hopper 112. The grain weight sensor may determine a weight of the feed 102 remaining in the hopper 112, which may be based at least in part on data from one or more of the feed level sensor 144 or the grain type sensor. The accelerometer may be used to detect tampering with the animal feeder. A tampering event may also be triggered when the lid is removed using only the feed level sensor 144.

In certain optional embodiments, the feed control unit 120 may include an accelerometer (not illustrated) to detect tampering with the feed control unit 120. In other optional embodiments, the feed control unit 120 may further include a camera for monitoring animals within the vicinity of the animal feeder 110. In further embodiments, artificial intelligence (AI) recognition may be implemented to determine pests versus wanted species of animals. In additional embodiments, the wireless feed control system 100 may include one or more lights and/or speakers (not illustrated) which are triggered upon sensing a pest is present at the animal feeder 110.

Referring to FIG. 3, the UI 180 displayed on the user device 104 may display on a main interface screen 182 a real time status of the feed control unit 120 and the feed level sensing unit 140 of the wireless feed control system 100. For example, a feed level and a battery level of one or more of the batteries 130, 148 may be displayed. The displayed data may be transmitted from the cloud server 160, which is in communication with the feed control unit 120. In certain optional embodiments, the cloud enables saving of data measurements (state) of the feeder for analysis to allow the user to know the state of the animal feeder 110 without being physically present. In certain optional embodiments, a user device 104 can directly connect to the wireless feed control system 100 (through the cloud server 160) using cellular data connections (e.g., LTE). In other optional embodiments, the cloud server 160 enables the user device 104 to connect the wireless feed control system 100 using Wi-Fi or similar local network that has internet connectivity, for example, when the user device 104 does not have access to a cellular network.

In certain optional embodiments, the main interface screen 182 of the UI 180 may include immediate commands, such as, for example, dispensing feed 102 from the animal feeder 110 immediately (e.g., on demand), irrespective of the feed schedule 186 thereof. The feed schedule 186 may also be referred to herein as normal feed scheduling 186, normal scheduling rules 186, or normal scheduling selection 186. The main interface screen 182 of the UI 180 may be configured to trigger on demand status updates from the feed control system 100, for example, the quality of feed, feed level, battery, of the like.

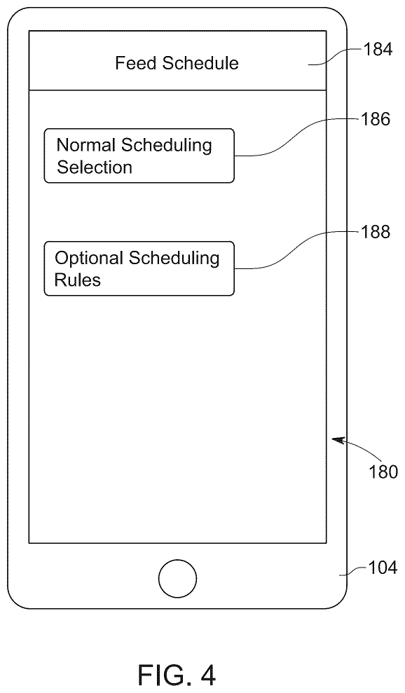

Referring to FIG. 4, the UI 180 may display a feed schedule selection screen 184 which allows a user to set automatic feed times where the feeder would spin (e.g., the electronic dispenser 114 is in an active state). The feed schedule selection screen 184 may include the selection of a normal feed scheduling 186 (e.g., time based) and optional scheduling rules 188. The normal scheduling rules 186 may correspond to triggering the animal feeder 110 at the same times every day. The optional scheduling rules 188 when enabled may automatically adjust or override one or more of the feed scheduled times from the normal scheduling selection 186. The optional scheduling rules 188 may be based at least in part on weather data (e.g., don't activate during rain, only activate if sunny, etc.), sunrise/sunset data, seasonal data (e.g., spring, summer, fall, winter), moon phase data, or any other event that a user would want to limit feeds by, for instance feed with a different schedule during planned hunting trips or feed with a different schedule during hunting season vs. feeding with a cycle for off season. The optional scheduling rules 188 may be enabled by receiving data from the cloud server 160 (e.g., third party weather service data, or the like) or by incorporation of local weather station monitoring. The optional scheduling rules 188 may also allow a user to select temporary modifications. For instance, ignore the next feed cycle. Alternatively, ignore feed cycles of the next 2 days, ignore the feed cycle for the next week, ignore the feed cycle for the next month, or ignore the feed cycles on Wednesdays only, etc.

In certain optional embodiments, the control module 128 may be configured to calculate an amount of time until the hopper 112 of the animal feeder 110 is empty. This calculation may be based at least in part on the feed schedule 186 and the data 142 from the feed level sensing unit 140. In further optional embodiments, the wireless feed control system 100 may be configured to adjust the feed schedule 186 or the activation time period of the electronic dispenser 114 based upon receiving a user input indicating the date of the next time the user will be able to physically get to the animal feeder 110 for refilling of the feed 102. This may help ensure that animals accustomed to feeding from the feeder continue to receive feed, as opposed to going days without feed and potentially wondering off in search of other sources of food.

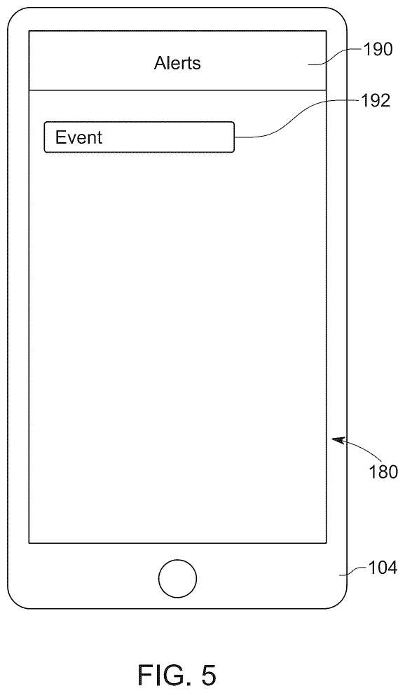

Referring to FIG. 5, the UI 180 may display one or more alerts 190 on the user device 104 which may be purposefully transmitted to the user device 104 in response to one or more events 192. The one or more events 192 may be measurement-based thresholds, scheduled timer commands, user execution commands (e.g., measurements, dispensing of feed, feed level threshold, battery level threshold, a malfunction of the electronic dispenser 114, etc.) or errors states. The malfunction of the electronic dispenser 114 may be one of a motor clog, a motor jam, a spin state, or the like. In certain optional embodiments, the one or more events may include a tampering event. In certain optional embodiments, the tampering event may be based on movement of the feed level sensing unit 140. In other optional embodiments, the tampering event may be based on data from an accelerometer positioned within one or more of the feed control unit 120 or the feed level sensing unit 140.

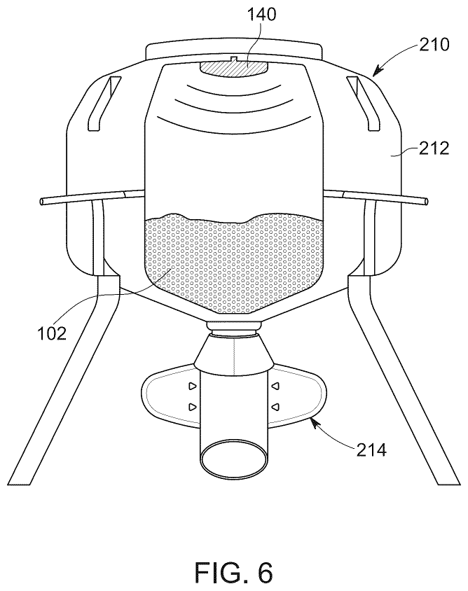

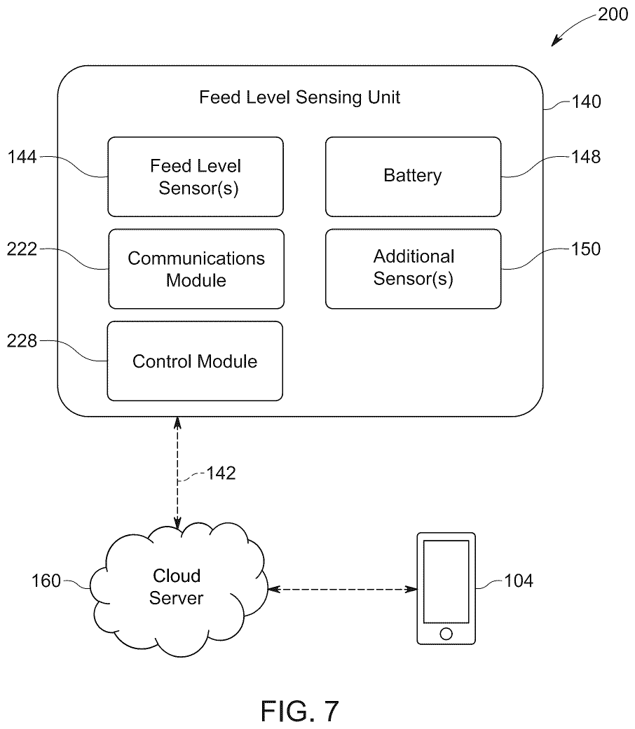

Referring to FIGS. 6-7, an embodiment of a system 200 in accordance with the present disclosure is shown. The system 200 may be similar to the wireless feed control system 100, however, it may only include the feed level sensing unit 140. Similar elements of the wireless feed control system 100 may be numbered similarly in the system 200. The system 200 may be ideal for all types of feeders 210 including gravity style feeders 210 having a normal dispenser 214, as the system 200 merely measures the amount of feed 102 left in a hopper 212 of the feeder 210.

As illustrated in FIG. 7, the feed level sensing unit 140 of the system 200 may include a communication module 222. The communication module 222 may replace the wireless transceiver 146 of the wireless feed control system 100, as illustrated in FIG. 2. The communication module 222 may function similar to the communication module 122 of the wireless feed control system 100.

In certain optional embodiments, the feed level sensing unit 140 of the system 200 may include a control module 228 configured to monitor historic feed level data associated with the particular feed level sensing unit and determine an approximate amount of time until the hopper 112 of the animal feeder 110 is empty (e.g., time until empty). The one or more alerts 190 may be based on the time until empty determination or data. In other optional embodiments, the cloud server may determine the time until empty data and transmit it using the UI 180.

In certain optional embodiments, the system 200 may further include a feed control unit 120, however, the communication components of the feed control unit 120 may be similar to those of the feed level sensing unit of the wireless feed control system 100.

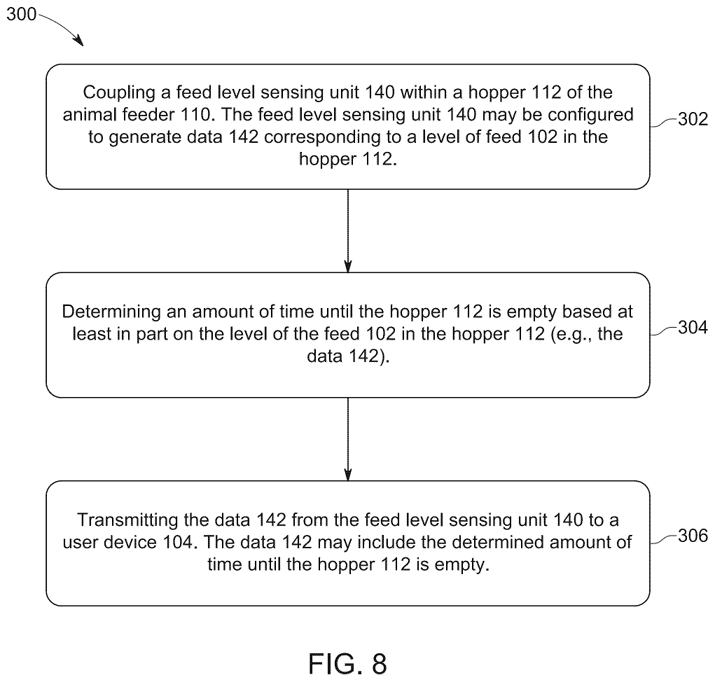

Referring to FIG. 8, a method 300 of monitoring an animal feeder 110, 210, is illustrated. The method 300 may include coupling 302 a feed level sensing unit 140 within a hopper 112 of the animal feeder 110. The feed level sensing unit 140 may be configured to generate data 142 corresponding to a level of feed 102 in the hopper 112. The method 300 may further include determining 304 an amount of time until the hopper 112 is empty based at least in part on the level of the feed 102 in the hopper 112 (e.g., the data 142). The method 300 may further include transmitting 306 the data 142 from the feed level sensing unit 140 to a user device 104. The data 142 may include the determined amount of time until the hopper 112 is empty.

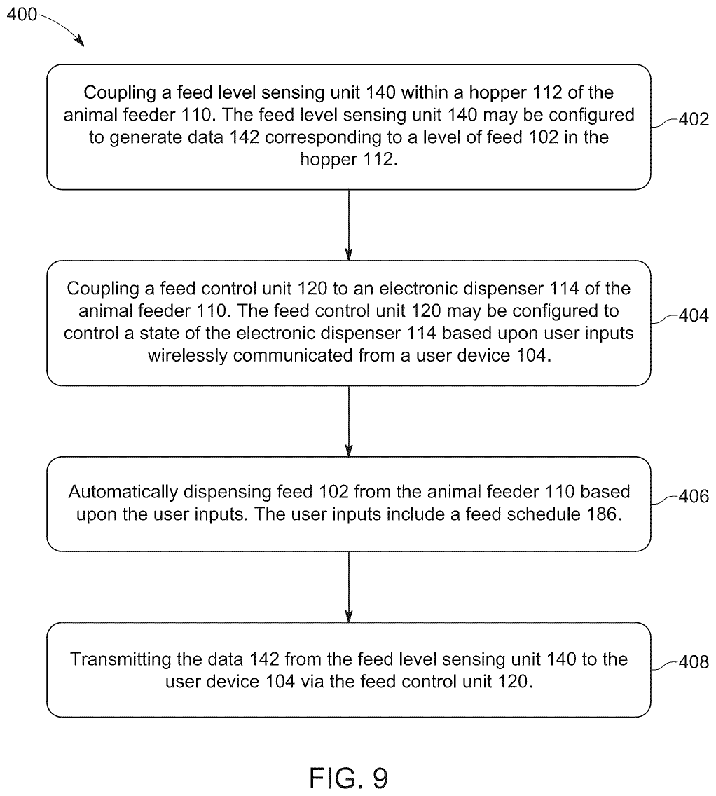

Referring to FIG. 9, a method 400 of controlling an animal feeder 110 is illustrated. The method 400 may include coupling 402 a feed level sensing unit 140 within a hopper 112 of the animal feeder 110. The feed level sensing unit 140 may be configured to generate data 142 corresponding to a level of feed 102 in the hopper 112. The method 400 may further include coupling 404 a feed control unit 120 to an electronic dispenser 114 of the animal feeder 110. The feed control unit 120 may be configured to control a state of the electronic dispenser 114 based upon user inputs wirelessly communicated from a user device 104. The method 400 may further include automatically dispensing 406 feed 102 from the animal feeder 110 based upon the user inputs. The user inputs include a feed schedule 186. The method 400 may further include transmitting 408 the data 142 from the feed level sensing unit 140 to the user device 104 via the feed control unit 120.

In certain optional embodiments, the feed schedule 186 may be one or more of time dependent, day dependent, weather dependent, season dependent, or sunrise/sunset dependent.

In other optional embodiments, the method 400 may further include determining an amount of time until the hopper is empty based at least in part on the level of the feed in the hopper and the feed schedule

In further optional embodiments, the method 400 may further include adjusting the feed schedule 186 based on the amount of time until the hopper 112 is empty to increase the amount of time until the hopper 112 is empty.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

Although embodiments of the present invention have been described in detail, it will be understood by those skilled in the art that various modifications can be made therein without departing from the spirit and scope of the invention as set forth in the appended claims.

A controller, computing device, or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A wireless feed control system configured to be coupled to an animal feeder including at least a hopper and an electronic dispenser, the wireless feed control system comprising:
a feed control unit configured to be coupled to the electronic dispenser of the animal feeder, the feed control unit including:
a network communication device configured to provide a cellular network connection to a cloud network accessible from a user device;
a local wireless receiver; and
a controller operatively configured to control a state of the electronic dispenser of the animal feeder based upon user inputs from the user device; and
a feed level sensing unit separate from the feed control unit and configured to be coupled within the hopper of the animal feeder, the feed level sensing unit configured to capture data corresponding to an amount of feed in the hopper and transmit the data to the feed control unit using a wireless transceiver in wireless communication with the local wireless receiver of the feed control unit,
wherein the data from the feed level sensing unit and additional data from the feed control unit are configured to be transmitted to the user device from the feed control unit.

2. The wireless feed control system of claim 1, wherein:
the user inputs include creating a feed schedule including automatic feed times when the state of the electronic dispenser is active.

3. The wireless feed control system of claim 2, wherein:
the controller is configured to calculate an amount of time until the hopper of the animal feeder is empty based at least in part on the feed schedule and the data from the feed level sensing unit.

4. The wireless feed control system of claim 2, wherein:
the user inputs include selection of one or more rules that automatically adjust or override one or more of the automatic feed times of the feed schedule; and
the one or more rules are based at least in part on one or more of whether data, seasonal data, moon phase data, or sunrise/sunset data.

5. The wireless feed control system of claim 1, wherein:
the feed control unit is configured to transmit one or more alerts from the feed control unit to the user device in response to one or more events.

6. The wireless feed control system of claim 5, wherein:
the one or more events includes tampering event.

7. The wireless feed control system of claim 6, wherein:
the tampering event is generated based on movement of the feed level sensing unit.

8. The wireless feed control system of claim 6, wherein:
the tampering event is generated based on data from an accelerometer positioned within one of the feed control unit or the feed level sensing unit.

9. The wireless feed control system of claim 8, wherein:
the one or more events includes a malfunction of the electronic dispenser of the animal feeder.

10. The wireless feed control system of claim 9, wherein:
the malfunction includes one or more of a jammed state, a clogged state, or a spin state.

11. The wireless feed control system of claim 1, wherein:
battery level data of the feed control unit is configured to be transmitted to the user device.

12. The wireless feed control system of claim 1, wherein:
the data captured by the feed level sensing unit includes a temperature associated with an interior of the hopper of the animal feeder.

13. The wireless feed control system of claim 1, wherein:
the data captured by the feed level sensing unit includes a humidity associated with an interior of the hopper of the animal feeder.

14. The wireless feed control system of claim 1, wherein:
the data captured by the feed level sensing unit includes one or more of a grain type or a grain weight associated with feed disposed within the hopper.

15. The wireless feed control system of claim 1, wherein:
the data captured by the feed level sensing unit includes a battery level measurement corresponding to batteries of the feed level sensing unit.

16. A method of monitoring an animal feeder, the method comprising:
coupling a feed level sensing unit within a hopper of the animal feeder, the feed level sensing unit configured to generate data corresponding to a level of feed in the hopper;
determining an amount of time until the hopper is empty based at least in part on the level of the feed in the hopper; and
transmitting the data from the feed level sensing unit to a user device, the data including the determined amount of time until the hopper is empty.

17. A method of controlling an animal feeder, the method comprising:
coupling a feed level sensing unit within a hopper of the animal feeder, the feed level sensing unit configured to generate data corresponding to a level of feed in the hopper;
coupling a feed control unit to an electronic dispenser of the animal feeder, the feed control unit configured to control a state of the electronic dispenser based upon user inputs wirelessly communicated from a user device;
automatically dispensing feed from the animal feeder based upon the user inputs, the user inputs include a feed schedule; and
transmitting the data from the feed level sensing unit to the user device via the feed control unit.

18. The method of claim 17, wherein:
the feed schedule is one or more of time dependent, day dependent, weather dependent, season dependent, or sunrise/sunset dependent.

19. The method of claim 17, further comprising:
determining an amount of time until the hopper is empty based at least in part on the level of the feed in the hopper and the feed schedule.

20. The method of claim 19, further comprising:
adjusting the feed schedule based on the amount of time until the hopper is empty to increase the amount of time until the hopper is empty.
